(19) United States
(12) Patent Application Publication
(10) Pub. No.: US 2007/0052223 A1
(43) Pub. Date: Mar. 8, 2007

(54) Inflatable curtain gas guide joint

(76) Inventors: David W. Parkinson, North Ogden, UT (US); Earl H. Nelson, West Haven, UT (US)

Correspondence Address: AUTOLIV ASP INC, 3350 AIRPORT ROAD, OGDEN, UT, 84405, US

(21) Appl. No.: 11/218,826

(22) Filed: Sep. 2, 2005

(51) Int. Cl. B60R 21/213; B60R 21/26

(52) U.S. Cl. 280/740; 280/730.2

(57) ABSTRACT

A collapsible gas guide for use in inflatable curtain airbags is disclosed. The gas guide may include two or more conduit segments that are interconnected by adjustable joints. The adjustable joints may permit adjustment of an angle formed between conduit segments that are coupled to the adjustable joint. The adjustable joint may rotatably or hingedly couple the conduit segments of the gas guide together.

### TECHNICAL FIELD

The present disclosure relates generally to the field of automotive protective systems. More specifically, the present disclosure relates to gas guides for use in directing inflation gas into an inflatable curtain airbag.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the invention's scope, the embodiments will be described and explained with specificity and detail in reference to the accompanying drawings in which:

FIG. 1A is a plan view of an embodiment of a gas guide in an operating configuration for directing inflation gas into an inflatable curtain airbag;

FIG. 1B is a plan view of the gas guide of FIG. 1A in a compact configuration;

FIG. 2A is a perspective view of one embodiment of an adjustable joint to be coupled to segments of a gas guide;

FIG. 2B is a perspective view of the adjustable joint of FIG. 2A in an alternative configuration;

FIG. 2C is a partially cut-away perspective view of the adjustable joint of FIG. 2A;

FIG. 3A is a perspective view of an another embodiment of an adjustable joint coupled to segments of a gas guide;

FIG. 3B is a perspective view of the adjustable joint and gas guide segments of FIG. 3A in an alternative configuration;

FIG. 3C is a partially cut-away perspective view of the adjustable joint and gas guide segments of FIG. 3A;

FIG. 4A is a perspective view of another embodiment of an adjustable joint to be coupled to segments of a gas guide;

FIG. 4B is a perspective view of the adjustable joint of FIG. 4A in an alternative configuration;

FIG. 4C is a partially cut-away perspective view of the adjustable joint of FIG. 4A;

FIG. 5A is a perspective view of another embodiment of an adjustable joint to be coupled to segments of a gas guide;

FIG. 5B is a perspective view of the adjustable joint of FIG. 5A in an alternative configuration;

FIG. 5C is an exploded perspective view of the adjustable joint of FIG. 5A;

FIG. 6A is a perspective view of another embodiment of an adjustable joint in an engaged position coupled to segments of a gas guide;

FIG. 6B is a perspective view of the adjustable joint of FIG. 6A in a disengaged position;

FIG. 6C is a perspective view of the adjustable joint of FIG. 6A in a alternative disengaged configuration;

FIG. 6D is a partially cut-away perspective view of the adjustable joint and gas guide segments of FIG. 6A in the engaged position;

FIG. 7A is a perspective view of another embodiment of an adjustable joint coupled to segments of a gas guide;

FIG. 7B is a perspective view of the adjustable joint of FIG. 7A in an alternative configuration;

FIG. 7C is a partially cut-away perspective view of the adjustable joint and gas guide segments of FIG. 7A;

FIG. 8A is a perspective view of another embodiment of an adjustable joint to be coupled to segments of a gas guide;

FIG. 8B is a perspective view of the adjustable joint of FIG. 8A in an alternative configuration;

FIG. 8C is a partially cut-away perspective view of the adjustable joint of FIG. 8A;

FIG. 9A is a perspective view of another embodiment of an adjustable joint coupled to segments of a gas guide;

FIG. 9B is a perspective view of the adjustable joint of FIG. 9A in an alternative configuration; and

FIG. 9C is an enlarged partially cut-away perspective view of the adjustable joint and gas guide segments of FIG. 9A.

### DETAILED DESCRIPTION OF PREFERRED EMBODIMENTS

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the invention, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abut” refers to items that are in direct physical contact with each other, although the items may not necessarily be attached together.

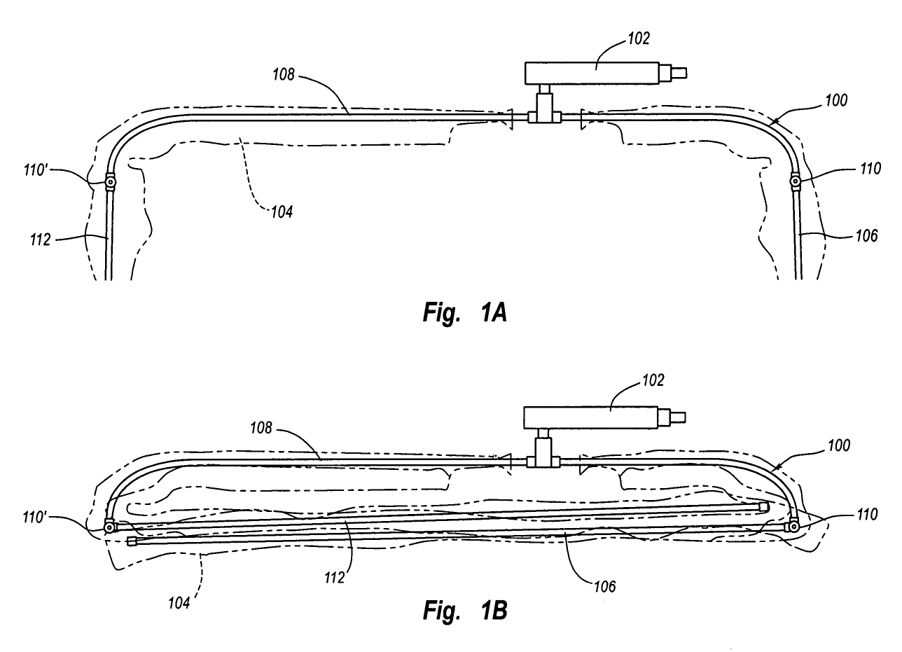

FIG. 1A represents one embodiment of a gas guide 100 coupled to an inflator 102 for directing inflation gas into an inflatable curtain airbag 104. The inflatable curtain 104 is shown in an uninflated state, and is depicted in phantom. The gas guide 100 is shown in an operating configuration as it would be installed inside a vehicle.

Inflatable curtains 104 are typically installed within a vehicle adjacent a roof rail and are designed to unfold or unroll downward to inflate beside an occupant to provide for impact protection and/or occupant retention during a lateral collision event. Since a vehicle occupant may be learning forward, reclined in a seat or positioned somewhere there between, inflatable curtains 104 may be somewhat long to provide sufficient coverage to ensure that the occupant is cushioned by the inflatable curtain 104 during a collision event.

Inflatable curtains 104 may be comprised of multiple chambers or multiple cushions. Therefore, a long flow path may exist between the inflator 102 and the chamber or cushion furthest from the inflator 102. The gas guide 100, sometimes referred to as a gas conduit or lance, may be disposed within the inflatable curtain 104 or otherwise in communication with the inflatable curtain 104 to channel inflation gas that is generated by the inflator 102 into the chambers or cushions of the inflatable curtain 104, including those that are furthest from the inflator 102.

The gas guide 100 may vary in length and orientation depending upon various factors, such as the size and type of vehicle that the inflatable curtain 104 is to be installed in and the mounting position of the inflator 102. For example, the gas guide 100 depicted in FIG. 1A has a U-shape, such that the prongs of the U are configured to be mounted adjacent the roof rails on each side of a vehicle, while the base of the U is configured to be mounted adjacent the roof rail in the rear of the vehicle.

In other alternative applications, the gas guide may be a substantially straight, or alternatively curved, conduit that is configured to be placed along a single side roof rail of a vehicle. Alternative configurations of the gas guide 100 in an operational configuration are known in the art and are considered to be within the scope of the present disclosure.

In some applications the length of the inflatable curtain 104 and corresponding gas guide 100 may be particularly long and difficult to handle during manufacturing and installation. Furthermore, long inflatable curtains 104 may otherwise require special shipping containers and handling criteria making them expensive to ship.

Accordingly, the gas guide 100 depicted is capable of being folded into multiple configurations to facilitate the manufacturing, shipping, and/or installation processes. The gas guide 100 has a first conduit segment 106 that is in communication with a second conduit segment 108 through an adjustable joint 110. The adjustable joint 110 interconnects the first and second conduit segments 106, 108 to allow for fluid communication of inflation gas there between.

Additionally, the gas guide 100 depicted includes a third conduit segment 112 that is in communication with the second conduit segment 108 through an additional adjustable joint 110′. Adjustable joint 110′ interconnects the second and third conduit segments 108, 112 to allow for fluid communication of inflation gas there between.

According to the exemplary embodiment of the gas guide 100 of FIG. 1A, the inflator 102 is coupled to the second conduit segment 108. The second conduit segment 108 channels inflation gas generated by the inflator 102 during a collision event to the first and third conduit segments 106, 112 and may also direct inflation gas out exit ports and into inflatable chambers that are disposed within the inflatable curtain 104. The first and third conduit segments 106, 112 also channel inflation gas into chambers within the inflatable curtain 104 and/or into additional conduit segments if desired.

FIG. 1B represents the gas guide 100 depicted in FIG. 1A, but shown in an alternative compact configuration. The gas guide 100 is folded through the adjustable joints 110, 110′, significantly reducing the length and bulkiness of the gas guide 100 module. By adjusting the configuration of joint 110′, the third conduit segment 112 is positioned in an approximately orthogonal orientation to its position in the extended operating configuration (shown in FIG. 1A). The first conduit segment 106 is also positioned in an approximately orthogonal orientation through adjustable joint 110, compared to its position in the extended operating configuration (shown in FIG. 1A).

Through adjustable joint 110, the first and second conduit segments 106, 108 are in articulating relationship with each other. Moreover, through adjustable joint 110′, the second and third conduit segments 108, 112 are in articulating relationship with each other. As would be apparent to one having skill in the art the gas guide 100 may be folded into multiple configurations to facilitate ease in manufacturing, shipping and installation. For example, during installation into a vehicle, the inflatable curtain 104 and associated gas guide 100 can more easily be inserted into the vehicle through the door or window openings in the compact configuration before being unfolded into the extended and operating configuration (see FIG. 1A) and secured into place.

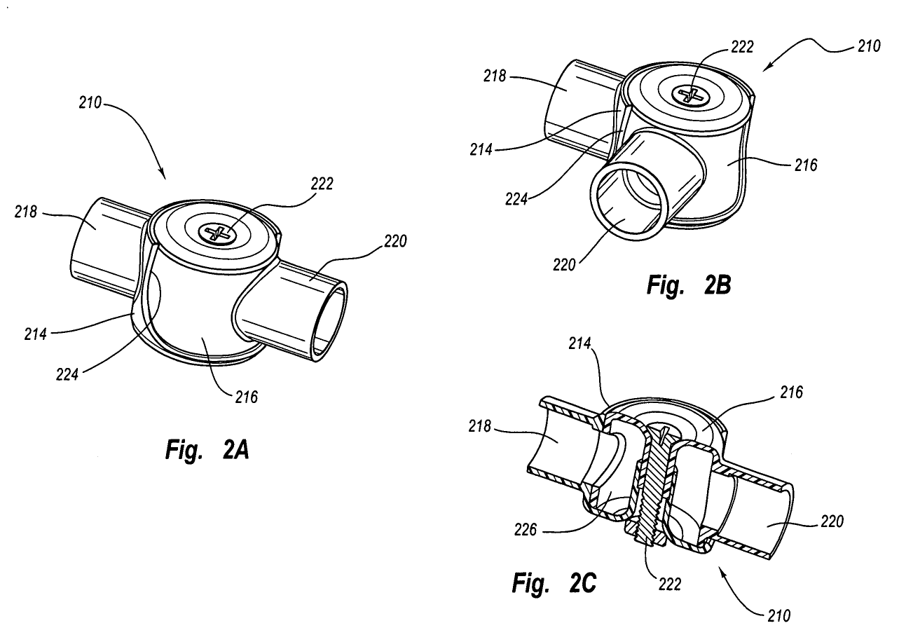

FIG. 2A represents one embodiment of an adjustable joint 210 to be coupled to segments of a gas guide (not shown) as illustrated from a perspective view. The adjustable joint 210 is illustrated in an operating configuration. The adjustable joint 210 may include a socket component 214 and an insert component 216 that is received by the socket component 214. The socket component 214 includes a first gas guide connection 218 that may be coupled to a conduit segment of the gas guide (not shown).

According to one embodiment, the conduit segment may be removable and re-connectable to the first gas guide connection 218. Alternatively, the socket component 214 may be an integrated part of the conduit segment. One with skill in the art would recognize that multiple methods of attachment may be employed to place the conduit segment in fluid communication with the first gas guide connection 218 so that inflation gas may pass there through.

The insert component 216 includes a second gas guide connection 220 for coupling to a conduit segment of the gas guide. The insert component 216 may nest inside the socket component 214 and is secured to the socket component 214 through a fastener 222. The fastener 222 may be a bolt and nut fastener as depicted, or optionally, alternative fasteners may be employed, such as a rivet or crimp. The insert component 216 is capable of rotational movement with respect to the socket component 214 along the axis that is approximately collinear with the fastener 222.

FIG. 2B represents an alternative configuration of the adjustable joint 210 of FIG. 2A as shown from a perspective view. According to the configuration depicted, the insert component 216 has been rotated within the socket component 214 to a position approximately 90° relative to the operating configuration illustrated in FIG. 2A. The axis of rotation may be collinear with the fastener 222. The configuration shown in FIG. 2B permits folding of the gas guide segments to which the adjustable joint 210 may be coupled.

The socket component 214 of the adjustable joint 210 may include a wall 224 which may be configured to guide the rotational movement of the insert component 216, and also control the degree of rotation of the adjustable joint 210. For example, the insert component 216 may be prevented from rotating any further in the clockwise direction since the second gas guide connection 220 abuts the socket wall 224, thus limiting the degree of rotation to 90°. However, as would be apparent to those having skill in the art, additional degrees of rotation may be permissible depending on the gas guide application.

FIG. 2C depicts the adjustable joint 210 of FIG. 2A from a partially cut-away perspective view. The adjustable joint 210 is shown in its operating configuration where the first gas guide connection 218 is positioned approximately 180° from the second gas guide connection 220. This view illustrates how the gas guide segments that are coupled to the adjustable joint 210 are in fluid communication with each other. For example, as inflation gas enters the adjustable joint through the first gas guide connection 218, it travels into a cavity 226 within the insert component 216. Inflation gas may flow around the fastener 222 and out of the adjustable joint 210 through the second gas guide connection 220. When the adjustable joint 210 is not in its operating configuration, the gas guide segments may not be in fluid communication with each other.

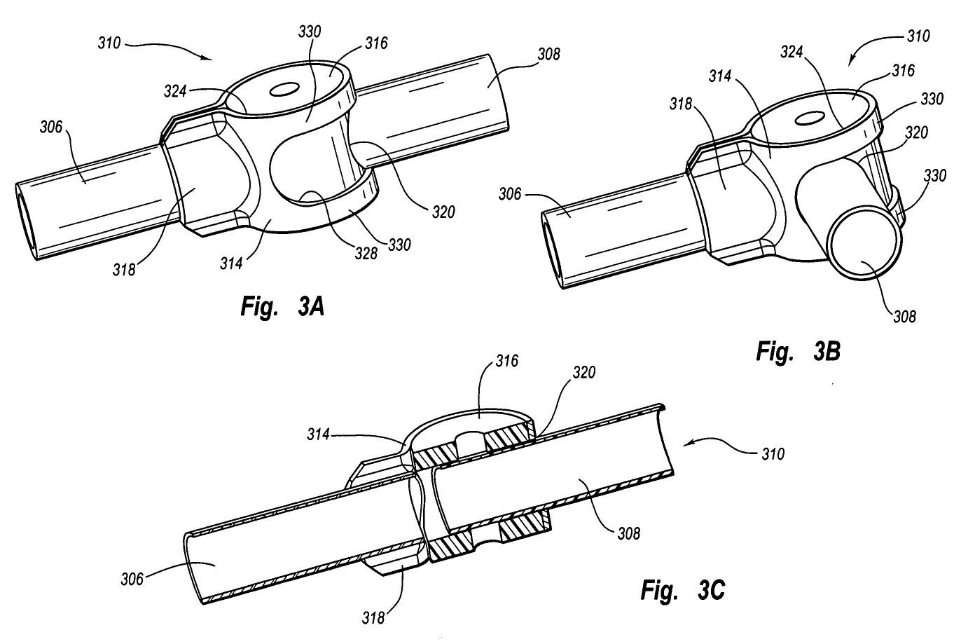

FIG. 3A represents another embodiment of an adjustable joint 310 that is coupled to and interconnects a portion of a first conduit segment 306 and a portion of a second conduit segment 308. The adjustable joint 310 is shown in an operating configuration. The adjustable joint 310 may include a socket component 314 and an insert component 316 that is received by the socket component 314.

The socket component 314 may include a first gas guide connection 318 for coupling to a portion of the first conduit segment 306. Alternatively, the socket component 314 may be an integrated part of the first conduit segment 306. The insert component 316 may be disposed within the socket component 314. The insert component 316 includes a second gas guide connection 320 for coupling the adjustable joint 310 to a portion of the second conduit segment 308. The second gas guide connection 320 may be an orifice in the insert component 316 sized to receive the second conduit segment 308.

The insert component 316 may be secured within the socket component 314 when the second conduit segment 308 is received by the second gas guide connection 320. The socket component 314 may have a channel 328 formed in the socket wall 324 where the second conduit segment 308 may extend through. The socket wall 324 may have annular portions 330 controlling the rotation of the insert component 316 and securing the insert component 316 within the socket 314 when the second conduit segment 308 is coupled thereto.

FIG. 3B represents an alternative configuration of the adjustable joint 310 of FIG. 3A as shown from a perspective view. The insert 316 has been rotated within the socket 314 to a position approximately 90° relative to the operating configuration illustrated in FIG. 3A. Consequently, the second conduit segment 308 is approximately orthogonal to the first conduit segment 306. Due to the orientation of the socket wall 324 and its annular portions 330, the second conduit segment 308 of the gas guide may rotate 180° within the socket 314, i.e., plus or minus 90° from the operating configuration of FIG. 3A. In alternative embodiments the second conduit segment 308 of the gas guide may rotate to greater or lesser angles, such as 210°, 90°, 120°, 240°, etc.

FIG. 3C represents the adjustable joint 310 of FIG. 3A from a partially cut-away perspective view. The adjustable joint 310 is depicted in its operating configuration where the first conduit segment 306 is at a 1800 angle with the second conduit segment 308. The adjustable joint 310 interconnects the first and second conduit segments 306, 308 and permits fluid communication there between. For example, inflation gas may enter the adjustable joint 310 through the first conduit segment 306 and flow into the second conduit segment 308 that is partially housed within the insert 316.

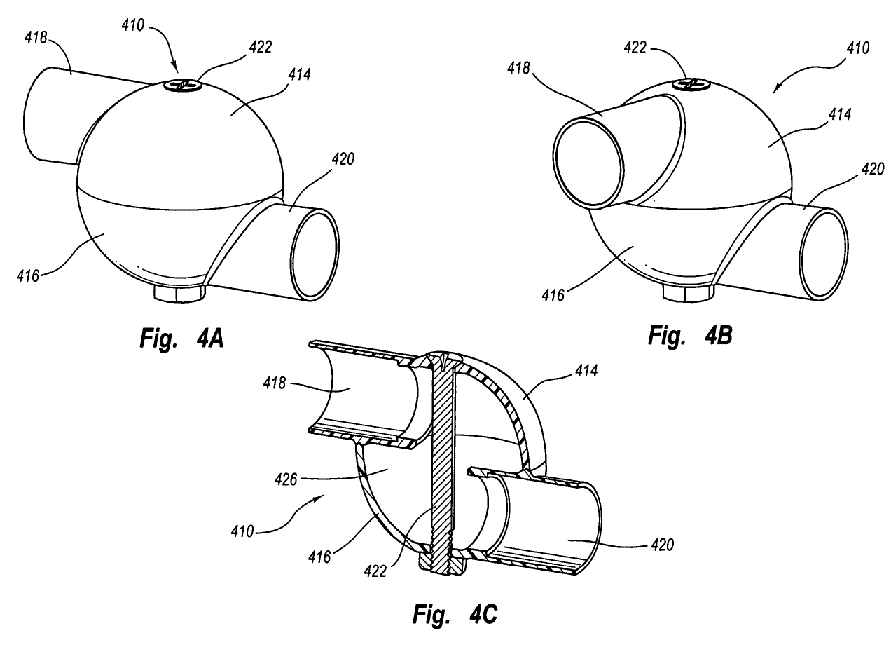

FIG. 4A represents another embodiment of an adjustable joint 410 that may be coupled to segments of a gas guide (not shown) as illustrated from a perspective view. The adjustable joint 410 may include a first cup component 414 and a second cup component 416 that may be coupled together through a fastener 422, such as a bolt and nut fastener 422. Alternative fastening mechanisms may be employed as apparent to those having skill in the art, such as a rivet, screw or crimp. The first and second cup components 414, 416 may abut each other at a swivel surface where the circumference of each cup component 414, 416 is the greatest.

The first cup 414 may include a first gas guide connection 418 that may be coupled to a gas guide conduit segment. Furthermore, the second cup 416 may include a second gas guide connection 420 for coupling to another gas guide conduit segment. The adjustable joint 410 is depicted in an operating configuration where the first gas guide connection 418 is at an angle of 180° from the second gas guide connection 420, and are also offset from each other, i.e., are not collinear.

The first and second cups 414, 416 are capable of rotational movement with respect to each other along the axis that is approximately collinear with the fastener 422. Consequently, the adjustable joint 410 may rotate a full 360°, so that the gas guide segments that are coupled thereto may be arranged in a variety of configurations as desirable. In alternative embodiments, the axis of rotation may be at a 45° angle to where the fastener 422 is located.

FIG. 4B represents an alternative configuration of the adjustable joint 410 of FIG. 4A as shown from a perspective view. According to the configuration depicted, the first cup component 414 has been rotated 90° with respect to the second cup component 416. The configuration of the gas guide connections 418, 420 and the first and second cups 414, 416 may place the gas guide module in a compact configuration. Alternatively, the gas guide module may be in the compact configuration when the first and second gas guide connections 418, 420 are at a 0° angle with respect to each other, i.e., the first and second gas guide connections 418, 420 extend in the same direction. This would allow some gas guide modules to essentially double back on themselves in the compact configuration.

FIG. 4C represents the adjustable joint of FIG. 4A from a partially cut-away perspective view. The adjustable joint 410 is shown in its operating configuration where the first gas guide connection 418 is positioned approximately 180° from the second gas guide connection 420. The gas guide connections 418, 420 are in fluid communication with each other through a cavity 426 that is created when the first and second cup components 414, 416 are coupled together.

During a collision event, inflation gas traveling from a first gas guide segment may enter the adjustable joint 410 from the first gas guide connection 418. The inflation gas then may travel from the first gas guide connection 418 to the second gas guide connection 420 via the cavity 426 disposed there between. The inflation gas may then exit the adjustable joint 410 at the second gas guide connection 420 and travel into a second gas guide segment.

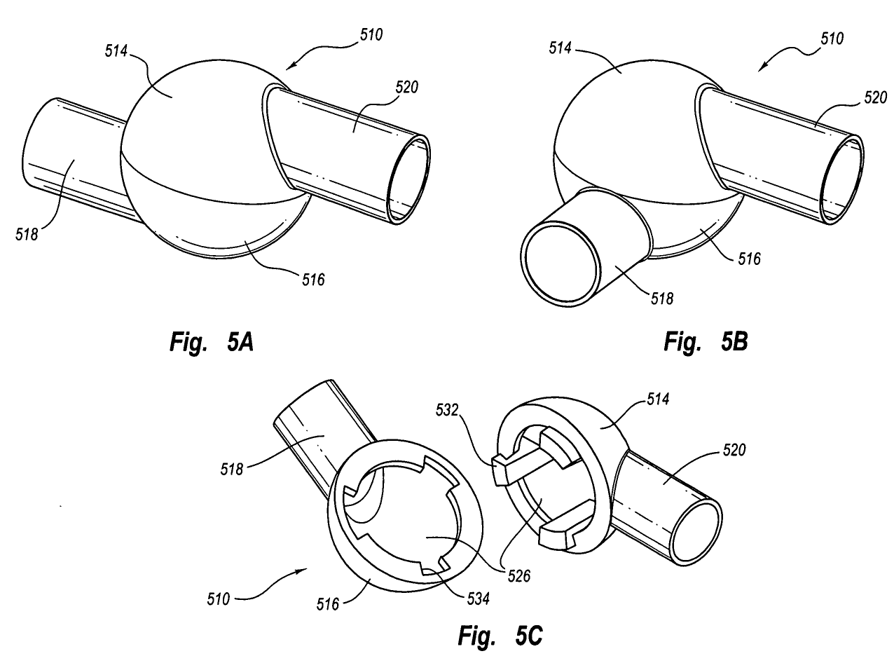

FIG. 5A represents yet another embodiment of an adjustable joint 510 that may be coupled to segments of a gas guide (not shown) as illustrated from a perspective view. Similar to the joint depicted in FIGS. 4A-4C, the present embodiment may include a first cup component 514 and a second cup component 516 that may be coupled together. The two cup components 514, 516 may abut each other where the circumference of each cup is the greatest. According to this embodiment, the adjustable joint 510 may be held together by a mechanism other than traditional bolts or screws, as will be described in greater detail in conjunction with FIG. 5C.

The first cup component 514 may include a first gas guide connection 518 that may be coupled to a gas guide conduit segment. Additionally, the second cup component 516 may include a second gas guide connection 520 for coupling to another gas guide conduit segment. The first and second cups 514, 516 are capable of rotational movement a full 360° with respect to each other, such that the gas guide connections 518, 520 may be positioned at various angles as desired. The adjustable joint 510 is depicted in an operating configuration where the first gas guide connection 518 is at an angle of 180° from the second gas guide connection 520.

FIG. 5B represents an alternative configuration of the adjustable joint 510 of FIG. 5A as shown from a perspective view. According to the configuration depicted, the first cup component 514 has been rotated approximately 90° with respect to the second cup component 516. Consequently, a gas guide segment that is coupled to the first gas guide connection 518 would be approximately orthogonal to a gas guide segment that is coupled to the second gas guide connection 520. The adjustable joint 510 permits the gas guide module to be folded into various configurations since the first and second cup components 514, 516 may be rotated to various angles within a full 360°.

FIG. 5C represents the adjustable joint 510 of FIG. 5A as shown from an exploded perspective view. When the first and second cup components 514, 516 are coupled together, they enclose a cavity 526 that exists in hollowed-out portions of the cup components 514, 516. The cavity 526 created within the adjustable joint 510 when the cup components 514, 516 are coupled together allows for fluid communication between the first and second gas guide connections 518, 520.

The cup components 514, 516 may be secured to each other through a fastening mechanism such as interlocking tabs or a clip. For example, the first cup component 514 may include interlocking tabs 532 that engage corresponding grooves 534 on the second cup component 516. According to one configuration, the tabs 532 and grooves 534 may engage when the cup components 514, 516 are placed at approximately a 30° angle relative to its operating configuration. The cup components 514, 516 may then be secured to each other by rotating one or both cups so that the tabs 532 are no longer aligned with the grooves 534. Other methods of attachment may be used as would be apparent to those having skill in the art.

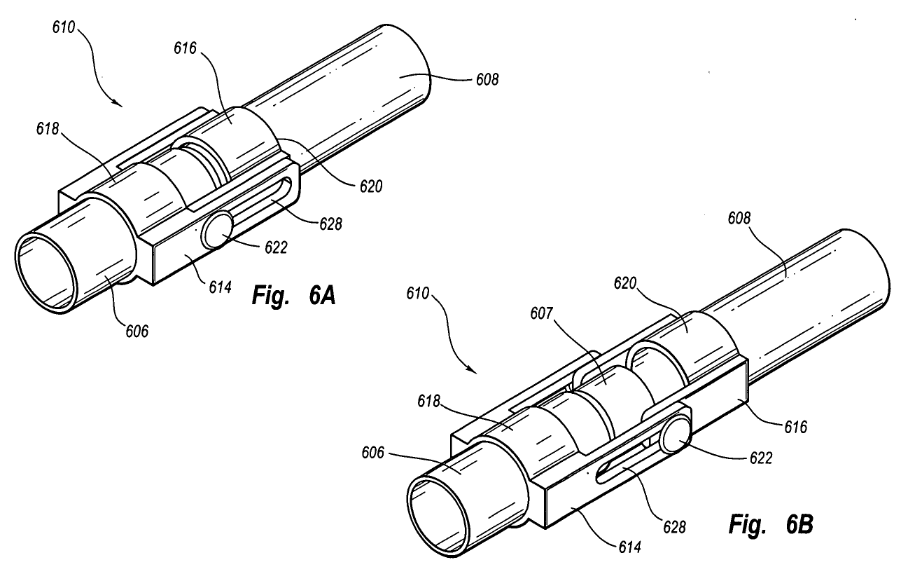

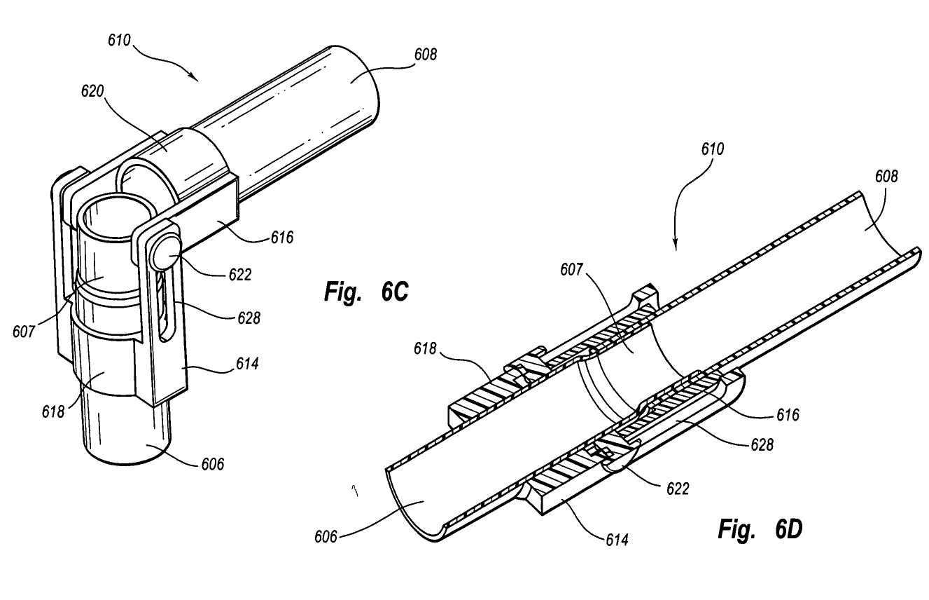

FIG. 6A represents another embodiment of an adjustable joint 610 in an engaged position as shown from a perspective view. The adjustable joint 610 interconnects a first conduit segment 606 and a second conduit segment 608. The adjustable joint 610 is illustrated in an operating configuration where the portions of the two conduit segments 606, 608 closest to the joint 610 form an angle of about 180°. As shown in FIG. 1A, the conduit segments may be bent themselves, therefore reference to the angle formed between conduit segments 606, 608 refers to the portions that are closest to the joint 610.

The adjustable joint 610 may include an outer hinge component 614 and an inner hinge component 616 that is received by the outer hinge component 614. On one end, the outer hinge 614 includes a first gas guide connection 618 for connecting to a first conduit segment 606. The other end the outer hinge 614 is coupled to the inner hinge 616. The first conduit segment 606 may be removably attachable to the outer hinge 614, or alternatively permanently affixable, or may be an integrated part of the outer hinge 614.

The inner hinge component 616 includes a second gas guide connection 620 for coupling to a second conduit segment 608. The outer and inner hinges 614, 616 are secured together through a fastener pin 622 or a plurality of fastener pins that engage a corresponding channel 628 in the outer hinge component 614. The first and second conduit segments 606, 608 are in fluid communication with each other in the engaged position of the adjustable joint 610.

FIG. 6B represents the adjustable joint 610 of FIG. 6A in a disengaged position as shown from a perspective view. The inner hinge 616 is slidably engaged with the outer hinge 614 through the fastener pins 622 and channels 628. In order to disengage the adjustable joint 610 the inner hinge component 616 slides away from the first conduit segment 606. When moving to the disengaged position, the inner hinge 616 and fastener pins 622 slide along their corresponding channel 628 to its end which may act as a stop.

A tapered end 607 of the first conduit segment 606 is exposed when the adjustable joint 610 is in the disengaged position. The tapered end 607 of the first conduit segment 606 may provide a positive lock and seal between the first and second conduit segments 606, 608 to allow fluid communication there between. Furthermore, the tapered end 607 may reduce the chance that the hinged joint 610 may pinch the inflatable curtain as the joint's configuration is altered. In the disengaged position, the first and second conduit segments 606, 608 are no longer in fluid communication with each other.

FIG. 6C represents the adjustable joint 610 of FIG. 6A in an alternative disengaged configuration as shown from a perspective view. Once the adjustable joint 610 is disengaged, the outer hinge component 614 may hingedly move relative to the inner hinge component 616. In the configuration shown in FIG. 6C, the outer hinge component 614 and corresponding first conduit segment 606 are approximately orthogonal to the inner hinge component 616 and corresponding second conduit segment 608. In the embodiment depicted in FIG. 6C, the hinged joint 610 may rotate a full 240°, i.e., plus or minus 120° in either direction from its operating configuration.

FIG. 6D represents the adjustable joint 610 and gas guide segments 606, 608 of FIG. 6A as shown from a partially cut-away perspective view. The adjustable joint 610 is shown in its operating configuration where the first conduit segment 606 is positioned approximately 180° from the second conduit segment 608. The gas guide segments 606, 608 are in fluid communication with each other through the adjustable joint 610. Fluid communication does not refer to air-tight coupling as some leakage of inflation gas out of the adjustable joint 610 is acceptable as the gas guide is disposed within the inflatable curtain.

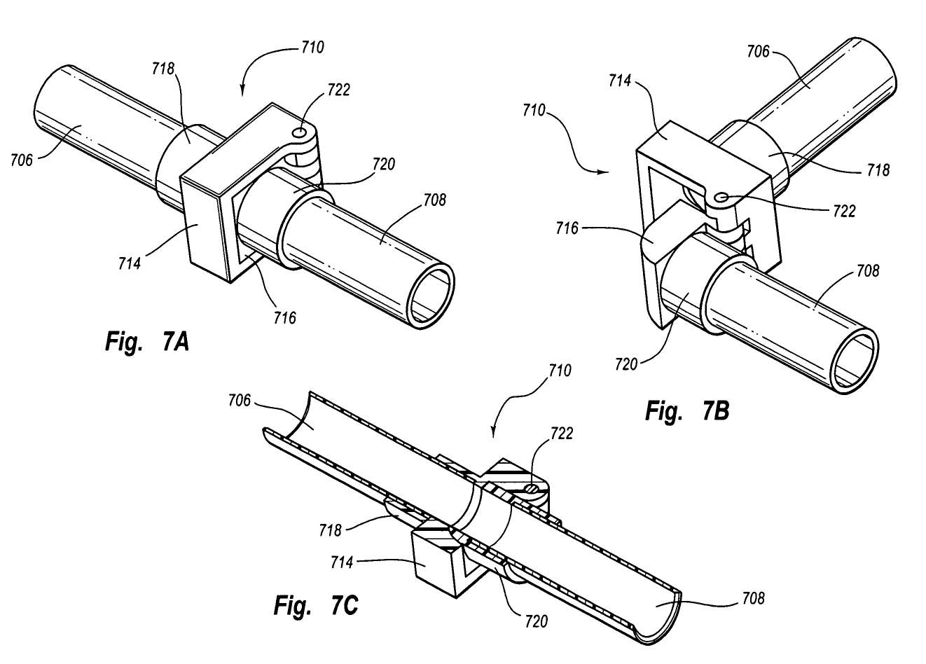

FIG. 7A represents an embodiment of an adjustable joint 710 coupled to first and second conduit segments 706, 708 as shown from a perspective view. The adjustable joint 710 is illustrated in an operating configuration where the portions of the two conduit segments 706, 708 closest to the joint 710 form an angle of about 180°.

The adjustable joint 710 depicted includes an outer hinge component 714 and an inner hinge component 716 that is received by the outer hinge component 714. The outer hinge 714 includes a first gas guide connection 718 for coupling to the first conduit segment 706. The inner hinge 716 includes a second gas guide connection 720 for coupling to the second conduit segment 708. The outer and inner hinges 714, 716 are hingedly secured together through a fastener pin 722 or similar device.

FIG. 7B represents an alternative configuration of the adjustable joint 710 of FIG. 7A as shown from a perspective view. In the configuration depicted, the inner hinge component 716 and accompanying second conduit segment 708 has hingedly moved to an approximately 90° angle relative to the outer hinge component 714 and first conduit segment 706. In the embodiment depicted, the hinged joint 710 may rotate 180° from its operating configuration. Adjustable joints configured to have more expansive or restrictive angles of rotation may be used as apparent to those having skill in the art.

FIG. 7C represents the adjustable joint 710 and gas guide segments 706, 708 of FIG. 7A as shown from a partially cut-away perspective view. The adjustable joint 710 is shown in its operating configuration having first and second conduit segments 706, 708 in fluid communication with each other through the adjustable joint 710. The first conduit segment 706 may optionally have a tapered end which may provide a positive lock and seal between the conduit segments 706, 708 as described in conjunction with the embodiment depicted in FIGS. 6A-6D.

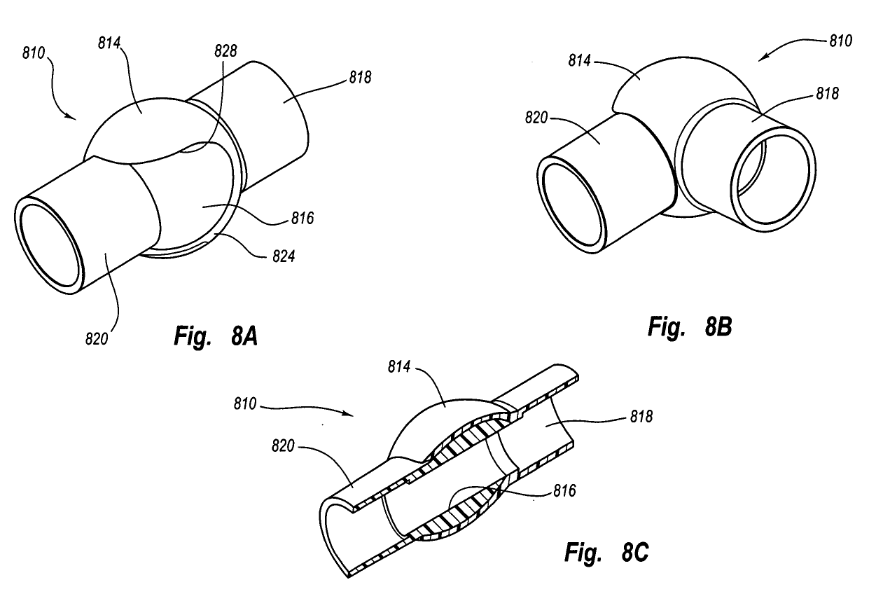

FIG. 8A represents another embodiment of an adjustable joint 810 configured to be coupled to segments of a gas guide module, as shown from a perspective view. The adjustable joint 810 is illustrated in an operating configuration. The adjustable joint 810 may include a socket component 814 and an insert or ball component 816.

The socket component 814 includes a first gas guide connection 818 that is configured to be coupled to a gas guide conduit segment (not shown). The ball component 816 also includes a second gas guide connection 820 for coupling to a gas guide conduit segment. Accordingly, the gas guide segments may be in fluid communication with each other through the adjustable joint 810.

The ball component 816 is rotatably secured within the socket component 814. This ball and socket joint 810 may be constructed, for example, by casting the inner ball component 816 and then overcastting the socket component 814 onto the ball 816. Prior to full cooling, the ball 816 may be broken loose from the socket 814 allowing the ball to be a separately moveable component from, but still secured within, the socket 814.

FIG. 8B represents the adjustable joint 810 of FIG. 8A in an alternative configuration, as shown from a perspective view. In the configuration depicted, the ball component 816 (shown in FIG. 8A) has been rotated within the socket component 814 to a position approximately 90° relative to the operating configuration of FIG. 8A. The ball 816 may be able to swivel freely inside the socket 814 as controlled by a socket wall 824 (shown in FIG. 8A).

The wall 824 of the socket component 814 may be configured to guide the rotational movement of the ball component 816 within the socket 814 as well as control the degree of rotation of the adjustable joint 810. This may be accomplished through a channel 828 (shown in FIG. 8A) formed in the socket wall 824. For example, the ball component 816 may be prevented from rotating any further than 90° relative to the operating configuration since the second gas guide connection 820 abuts the socket wall 824. However, alternative degrees of rotation may be used depending on the gas guide application as apparent to those having skill in the art.

FIG. 8C depicts the adjustable joint 810 of FIG. 8A from a partially cut-away perspective view. The adjustable joint 810 is illustrated in its operating configuration where the first gas guide connection 818 is positioned approximately 180° from the second gas guide connection 820. The gas guide segments that may be coupled thereto are in fluid communication with each other through the adjustable joint 810.

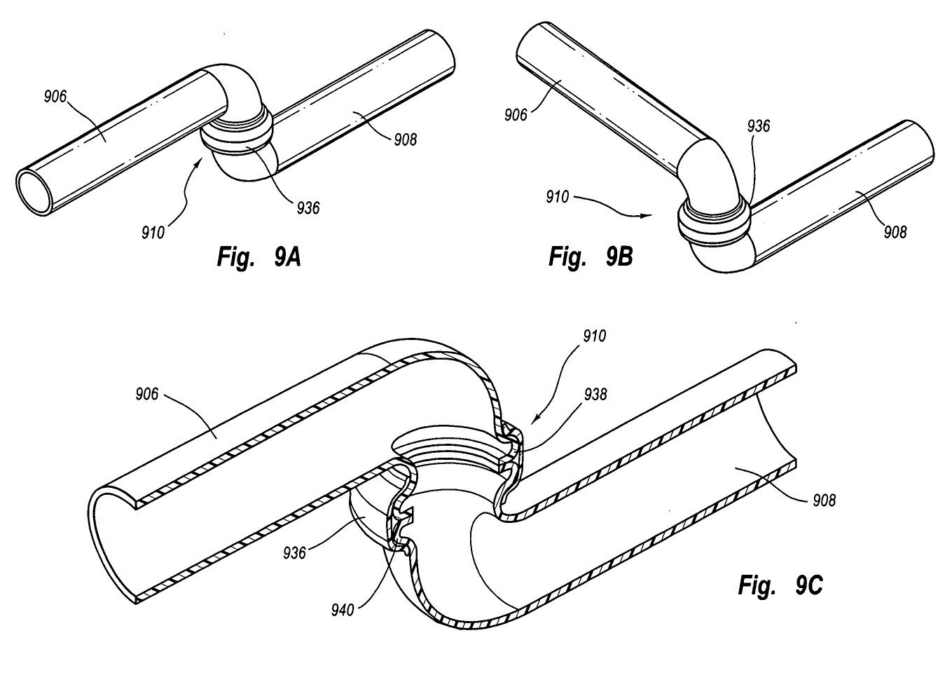

FIG. 9A is another embodiment of an adjustable joint 910 coupled to first and second conduit segments 906, 908 of a gas guide module as shown from a perspective view. The adjustable joint 910 may comprise an elbow portion of the first conduit segment 906 and an elbow portion of the second conduit segment 908 secured together through a crimped joining piece 936 or clip. According to the embodiment depicted, components of the adjustable joint 910 are an integrated part of the gas guide segments 906, 908.

FIG. 9B represents the adjustable joint 910 of FIG. 9A in an alternative configuration, as shown from a perspective view. According to the configuration depicted, the first conduit segment 906 has been rotated about 90° relative to the configuration depicted in FIG. 9A, such that the first conduit segment 906 is approximately orthogonal to the second conduit segment 908. The conduit segments 906, 908 are able to swivel a full 360° to a desired angle for manufacturing, shipping, handling or installation of the gas guide module as needed.

FIG. 9C depicts the adjustable joint 910 of FIG. 9A from a partially cut-away perspective view. The first conduit segment 906 has a flared end 938 at its elbow end. Moreover, the second conduit segment 908 has a flared end 940 at its elbow end. The flared ends 938, 940 of the conduit segments 906, 908 are positioned adjacent each other and circumscribed or otherwise clipped by the crimped joining piece 936.

The first and second conduit segments 906, 908 are in fluid communication with each other through the adjustable joint 910. For example, as inflation gas enters the adjustable joint 910 through the first conduit segment 906, it travels around the elbow portion and into the adjustable joint 910 circumscribed by the crimped joining piece 936. Inflation gas may then travel into the elbow portion of the second conduit segment 908 and out the adjustable joint 910.

The airbags and inflatable curtains, cushions and chambers disclosed herein are examples of means for cushioning a vehicle occupant during a collision event. Furthermore, the gas guides, lances, and conduit segments disclosed herein are examples of means for channeling inflation gas from an inflator into the cushioning means. Moreover, the adjustable joints disclosed are examples of means for articulately coupling conduit segments together.

Without further elaboration, it is believed that one skilled in the art can use the preceding description to utilize the invention to its fullest extent. The examples and embodiments disclosed herein are to be construed as merely illustrative and not a limitation of the scope of the present invention in any way. It will be apparent to those having skill in the art that changes may be made to the details of the above-described embodiments without departing from the underlying principles of the invention. In other words, various modifications and improvements of the embodiments specifically disclosed in the description above are within the scope of the appended claims. Note that elements recited in means-plus-function format are intended to be construed in accordance with 35 U.S.C. §112¶6. The scope of the invention is therefore defined by the following claims.

1. A gas guide for use in directing inflation gas into an inflatable curtain airbag, the gas guide comprising:
a first conduit segment configured to channel inflation gas;
a second conduit segment configured to channel inflation gas; and
an adjustable joint that interconnects the first and second conduit segments, the joint permitting adjustment of an angle formed between portions of the first and second conduit segments that are coupled to the adjustable joint.

2. The gas guide of claim 1, further comprising:
a third conduit segment configured to channel inflation gas; and
an additional adjustable joint that interconnects the second and third conduit segments permitting adjustment of an angle formed between portions of the second and third conduit segments that are coupled to the additional adjustable joint.

3. The gas guide of claim 1, wherein the adjustable joint rotatably couples the first and second conduit segments together.

4. The gas guide of claim 1, wherein the adjustable joint hingedly couples the first and second conduit segments together.

5. The gas guide of claim 1, wherein the adjustable joint permits the first and second conduit segments to be in an extended operating configuration or a compact configuration.

6. The gas guide of claim 5, wherein the angle formed between the portions of the first and second conduit segments that are coupled to the adjustable joint in the extended operating configuration is about 180°.

7. The gas guide of claim 1, wherein the first and second conduit segments are in fluid communication with each other through the adjustable joint.

8. The gas guide of claim 1, wherein the adjustable joint has a first component integrated with the first conduit segment and a second component integrated with the second conduit segment.

9. The gas guide of claim 1, wherein the first and second conduit segments are removable from the adjustable joint.

10. The gas guide of claim 1, wherein the adjustable joint is comprised of components that move relative to each other and are secured together by a fastener.

11. The gas guide of claim 10, wherein the fastener is a bolt.

12. The gas guide of claim 10, wherein the fastener is a clip.

13. An inflatable curtain airbag assembly, comprising:
an inflatable curtain having inflatable chambers disposed therein; and
a gas guide configured to direct inflation gas into the inflatable chambers, the gas guide comprising:
a first conduit segment; and
a second conduit segment in articulating relationship with the first conduit segment.

14. The airbag assembly of claim 13, wherein the gas guide further comprises a third conduit segment in articulating relationship with the second conduit segment.

15. The airbag assembly of claim 14, wherein the conduit segments of the gas guide may be arranged in multiple configurations relative to each other.

16. The airbag assembly of claim 13, wherein the gas guide further comprises an adjustable joint interconnecting the conduit segments to provide the articulating relationship between the conduit segments.

17. The airbag assembly of claim 16, wherein the first and second conduit segments are in fluid communication with each other through the adjustable joint.

18. The airbag assembly of claim 17, wherein the adjustable joint comprises a socket component and an insert component received by the socket component.

19. The airbag assembly of claim 17, wherein the adjustable joint comprises a first cup component coupled to the first conduit segment and a second cup component coupled to the second conduit segment, such that the first and second cup components are rotatably coupled to each other.

20. The airbag assembly of claim 17, wherein the adjustable joint is a hinged joint comprising an outer hinge component and an inner hinge component received by the outer hinge component.

21. The airbag assembly of claim 17, wherein the first and second conduit segments each comprise a flared end and the adjustable joint comprises a crimped joining piece coupled to the flared ends of the conduit segments.

22. An inflatable airbag assembly, comprising:
means for cushioning a vehicle occupant in a collision event; and
means for channeling inflation gas from an inflator into the cushioning means, the channeling means comprising a plurality of conduit segments in communication with each other through means for articulately coupling the conduit segments together.
